(19) United States
(12) Patent Application Publication
(10) Pub. No.: US 2022/0082851 A1
(43) Pub. Date: Mar. 17, 2022

(54) OPTICAL UNIT

(71) Applicant: NIDEC CORPORATION, Kyoto (JP)

(72) Inventors: Takayuki IWASE, Kyoto (JP); Tomohiro EGAWA, Kyoto (JP); Keishi OTSUBO, Kyoto (JP); Kazuhiro SAZAI, Kyoto (JP); Genki TANAKA, Kyoto (JP)

(21) Appl. No.: 17/473,953

(22) Filed: Sep. 13, 2021

(30) Foreign Application Priority Data
Sep. 14, 2020 (JP) 2020-154051

(51) Int. Cl. G02B 27/64; G02B 7/18

(52) U.S. Cl. CPC G02B 27/646; G02B 7/1805

(57) ABSTRACT

An optical unit includes a movable body, a support, and a swing mechanism. The movable body includes an optical element that changes a traveling direction of light. The support supports the movable body in a manner that the movable body is swingable about a swing axis. One of the movable body and the support has at least three protrusions. The other of the movable body and the support has an axial center recess. The at least three protrusions are disposed on the same circumference about the swing axis. The recess constitutes at least a part of a circle around the swing axis.

### CROSS-REFERENCE TO RELATED APPLICATIONS

The present invention claims priority under 35 U.S.C. § 119 to Japanese Patent Application No. 2020-154051 filed on Sep. 14, 2020, the entire content of which is incorporated herein by reference.

### FIELD OF THE INVENTION

The present disclosure relates to an optical unit.

### BACKGROUND

When a still image or a moving image is captured by a camera, image blurring may occur due to camera shake. Then, a camera shake correction device for suppressing image blurring and enabling clear photographing has been put into practical use. When camera shake occurs, the camera shake correction device suppresses image blurring by correcting the posture of a camera module according to the camera shake.

Conventionally, a prism module including a first base, a prism, and a first shake correction device is known. The first shake correction device includes a pair of swing support springs, a holder, and a first actuator. The holder holds the prism. A pair of the swing support springs supports the holder in a manner swingable with respect to the first base. The first actuator swings the holder about a first axis.

However, in the conventional prism module, since the holder is supported by the first base via the swing support spring, the swing center is not fixed. Therefore, it is difficult to stably swing the holder with respect to the first base. Therefore, it is difficult to improve correction accuracy.

### SUMMARY

An exemplary optical unit of the present disclosure includes a movable body, a support, and a swing mechanism. The movable body includes an optical element that changes a traveling direction of light. The support supports the movable body in a manner that the movable body is swingable about a swing axis. The swing mechanism swings the movable body about the swing axis. One of the movable body and the support has at least three protrusions protruding toward the other of the movable body and the support. The other of the movable body and the support has a recess recessed in a direction opposite to the protrusion. The at least three protrusions are arranged on the same circumference around the swing axis and protrude in an axial direction of the swing axis. The recess is in contact with the protrusion and constitutes at least a part of a circle around the swing axis.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating a smartphone including an optical unit according to an embodiment of the present disclosure;

FIG. 2 is a perspective view illustrating an optical unit according to the present embodiment;

FIG. 3 is an exploded perspective view of the optical unit according to the present embodiment disassembled into a movable body and a support;

FIG. 4 is an exploded perspective view of the movable body of the optical unit according to the present embodiment;

FIG. 5A is a cross-sectional view taken along line VA-VA of FIG. 2;

FIG. 5B is a cross-sectional view taken along line VB-VB of FIG. 2;

FIG. 5C is a cross-sectional view taken along line VC-VC of FIG. 2;

FIG. 6 is an exploded perspective view of an optical element and a holder of the optical unit according to the present embodiment;

FIG. 7 is an exploded perspective view of a first preload unit, a first support portion, and a second magnet of the optical unit according to the present embodiment;

FIG. 8 is a cross-sectional view of the first preload unit of the optical unit according to the present embodiment;

FIG. 9 is a perspective view illustrating the movable body of the optical unit according to the present embodiment;

FIG. 10 is a diagram illustrating the first support portion of the optical unit according to the present embodiment from a first side X1 in a first direction X;

FIG. 11 is an exploded perspective view of a support of the optical unit according to the present embodiment;

FIG. 12 is a perspective view illustrating a periphery of a second support portion of the optical unit according to the present embodiment;

FIG. 13 is a diagram illustrating the second support portion of the optical unit according to the present embodiment from a second side X2 in the first direction X;

FIG. 14 is a diagram illustrating the second support portion, an axial center protrusion, the second magnet, and a third magnet of the optical unit according to the present embodiment from the second side X2 in the first direction X;

FIG. 15 is a cross-sectional view illustrating a structure around the first preload unit of the optical unit according to a first variation of the present embodiment;

FIG. 16 is a cross-sectional view illustrating the optical unit according to a second variation of the present embodiment;

FIG. 17 is a perspective view illustrating the movable body of the optical unit according to a third variation of the present embodiment;

FIG. 18 is a perspective view illustrating the support of the optical unit according to the third variation of the present embodiment;

FIG. 19 is a perspective view illustrating the movable body of the optical unit according to a fourth variation of the present embodiment;

FIG. 20 is a diagram illustrating the second support portion, the axial center protrusion, the second magnet, and the third magnet of the optical unit according to a fifth variation of the present embodiment from the second side X2 in the first direction X;

FIG. 21 is a diagram illustrating the second support portion, the axial center protrusion, and the third magnet of the optical unit according to a sixth variation of the present embodiment from the second side X2 in the first direction X; and

FIG. 22 is a cross-sectional view illustrating the optical unit according to a seventh variation of the present embodiment.

### DETAILED DESCRIPTION

Hereinafter, exemplary embodiments of the present disclosure will be described with reference to the accompanying drawings. In the drawings, the same or corresponding portions are denoted by the same reference numerals, and the description of such portions will not be repeated.

In the present specification, a first direction X, a second direction Y, and a third direction Z intersecting each other are appropriately described for easy understanding. Further, in the present specification, the first direction X, the second direction Y, and the third direction Z, which are orthogonal to each other, do not need to be orthogonal to each other. Further, one side in the first direction is referred to as a first side X1 in the first direction X, and the other side in the first direction is referred to as a second side X2 in the first direction X. Further, one side in the second direction is referred to as a first side Y1 in the second direction Y, and the other side in the second direction is referred to as a second side Y2 in the second direction Y. Further, one side in the third direction is referred to as a first side Z1 in the third direction Z, and the other side in the third direction is referred to as a second side Z2 in the third direction Z. For convenience, the first direction X may be described as an upward/downward direction. The first side X1 in the first direction X indicates a downward direction, and the second side X2 in the first direction X indicates an upward direction. However, the upward/downward direction, the upward direction, and the downward direction are defined for convenience of description, and do not need to coincide with a vertical direction. Furthermore, the upward/downward direction is merely defined for convenience of description, and the direction at the time of use and assembly of the optical unit according to the present disclosure is not limited.

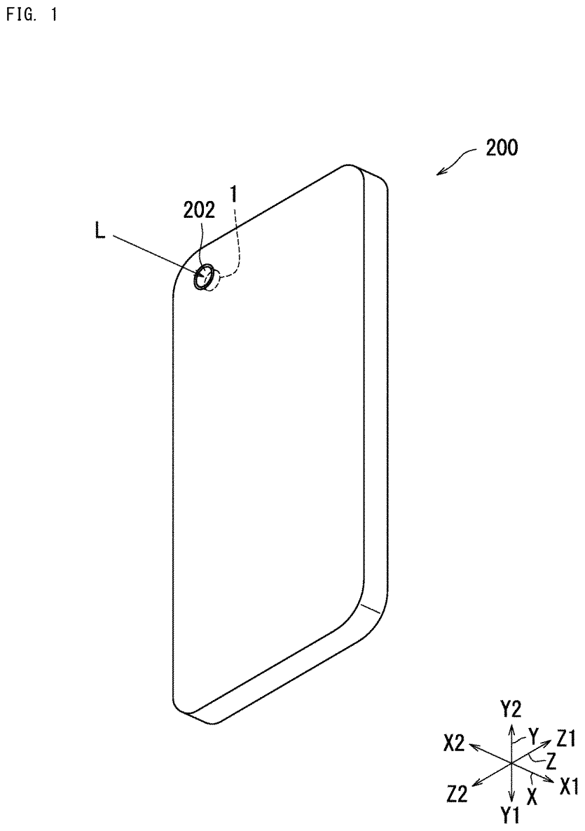

First, an example of use of an optical unit 1 will be described with reference to FIG. 1. FIG. 1 is a perspective view schematically illustrating a smartphone 200 including the optical unit 1 according to an embodiment of the present disclosure. The optical unit 1 reflects incident light in a specific direction. As illustrated in FIG. 1, the optical unit 1 is suitably used as, for example, an optical component of the smartphone 200. The use of the optical unit 1 is not limited to the smartphone 200, and the optical unit 1 can be used for various devices such as a digital camera and a video camera.

The smartphone 200 includes a lens 202 on which light is incident. In the smartphone 200, the optical unit 1 is disposed on the inner side than the lens 202. When light L enters the inside of the smartphone 200 via the lens 202, the traveling direction of the light L is changed by the optical unit 1. Then, the light L is imaged by an imaging element (not illustrated) via a lens (not illustrated).

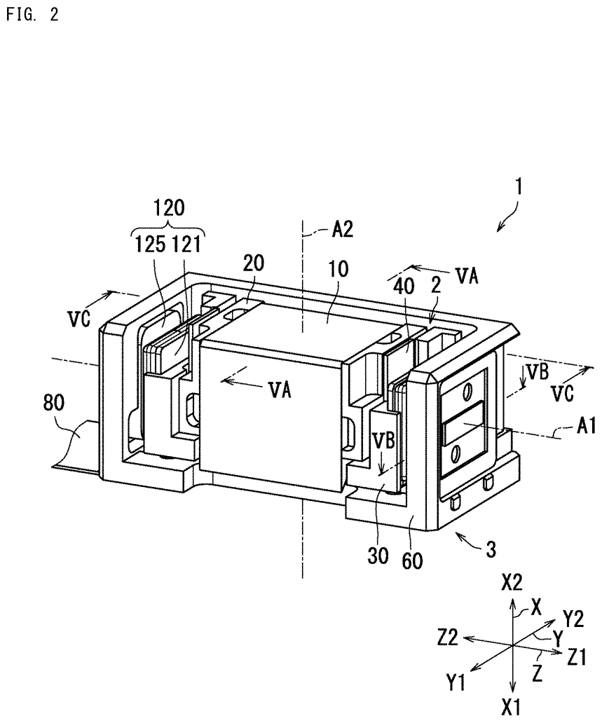

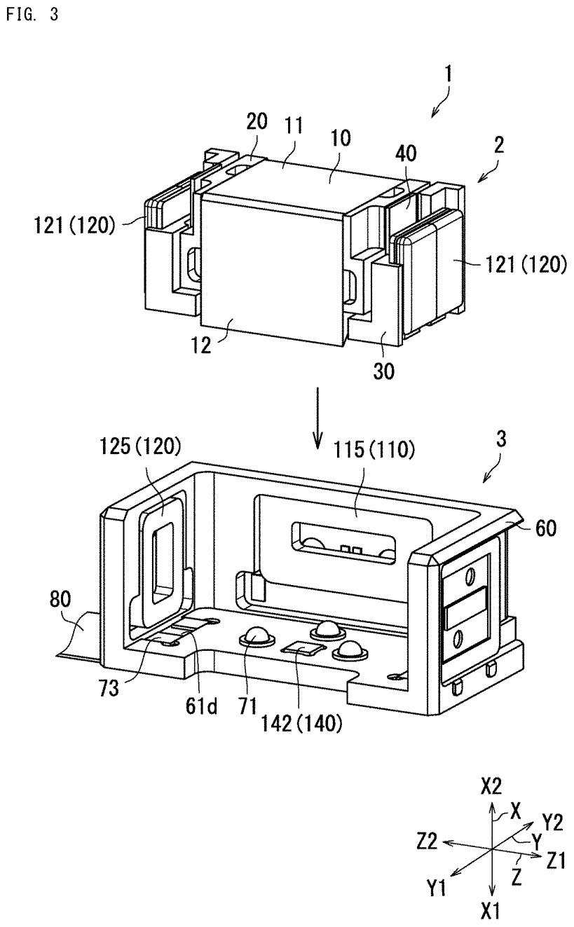

Next, the optical unit 1 will be described with reference to FIGS. 2 to 14. FIG. 2 is a perspective view illustrating the optical unit 1 according to the present embodiment. FIG. 3 is an exploded perspective view of the optical unit 1 according to the present embodiment disassembled into a movable body 2 and a support 3. As illustrated in FIGS. 2 and 3, the optical unit 1 includes at least the movable body 2, the support 3, and a second swing mechanism 120. In the present embodiment, the optical unit 1 further includes a second preload unit 140 disposed on at least one of the movable body 2 and the support 3. In the present embodiment, the optical unit 1 further includes a first swing mechanism 110, a first preload unit 40, and a flexible printed circuit (FPC) 80. Note that the second swing mechanism 120 is an example of the “swing mechanism” of the present disclosure. Further, the second preload unit 140 is an example of the “preload unit” of the present disclosure. Details will be described below.

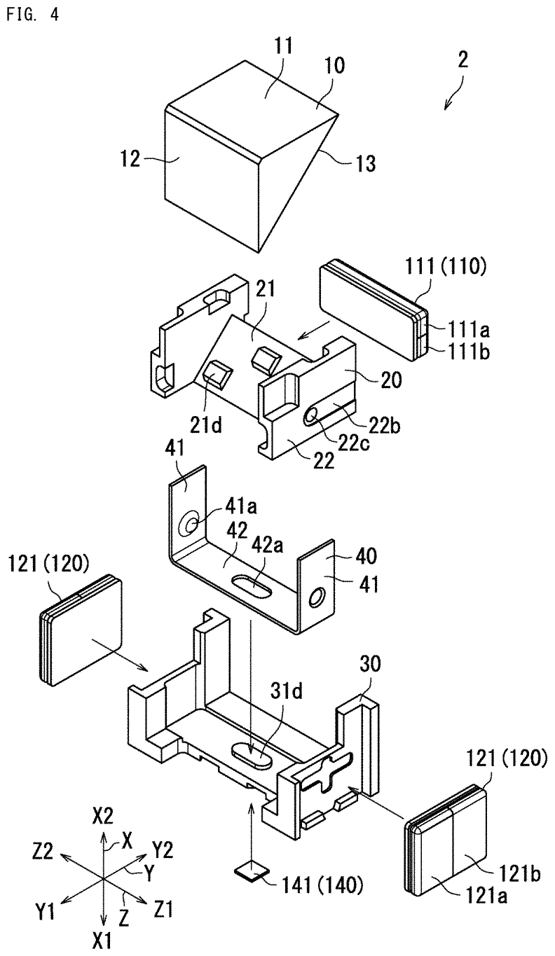

FIG. 4 is an exploded perspective view of the movable body 2 of the optical unit 1 according to the present embodiment. As illustrated in FIGS. 2 to 4, the optical unit 1 includes the movable body 2 and the support 3. The support 3 supports the movable body 2 in a manner that the movable body 2 is swingable about a second swing axis A2. Note that the second swing axis A2 is an example of the “swing axis” of the present disclosure.

The movable body 2 has an optical element 10. Further, the movable body 2 includes a holder 20, a first support portion 30, and the first preload unit 40. Note that the first support portion 30 is an example of the “support portion” of the present disclosure. The optical element 10 changes a traveling direction of light. The holder 20 holds the optical element 10. The first support portion 30 supports the holder 20 and the optical element 10 in a manner that the holder 20 and the optical element 10 are swingable about the first swing axis A1. Further, the first support portion 30 is supported by the support 3 in a manner swingable about a second swing axis A2. More specifically, the first support portion 30 is supported by a second support portion 60 of the support 3 in a manner swingable about the second swing axis A2.

That is, the holder 20 is swingable with respect to the first support portion 30, and the first support portion 30 is swingable with respect to the second support portion 60. Therefore, since the optical element 10 can be swung about each of the first swing axis A1 and the second swing axis A2, the posture of the optical element 10 can be corrected about each of the first swing axis A1 and the second swing axis A2. Therefore, image blurring can be suppressed regardless of a direction of camera shake. As a result, the correction accuracy can be improved as compared with a case where the optical element 10 is swung about only one swing axis. Note that the first swing axis A1 is also referred to as a pitching axis. The second swing axis A2 is also referred to as a roll axis.

The first swing axis A1 is an axis extending along the third direction Z. The second swing axis A2 is an axis extending along the first direction X. Therefore, the optical element 10 can be swung about the first swing axis A1 intersecting the first direction X and the second direction Y. Further, it is possible to stably swing the optical element 10 about the second swing axis A2 extending along the first direction X. Therefore, the posture of the optical element 10 can be appropriately corrected. Note that the first direction X and the second direction Y are directions along a traveling direction of the light L.

The first support portion 30 supports the holder 20 in the third direction Z. Therefore, the first support portion 30 can be easily swung about the first swing axis A1 extending along the third direction Z. Specifically, in the present embodiment, the first support portion 30 supports the holder 20 in the third direction Z via the first preload unit 40.

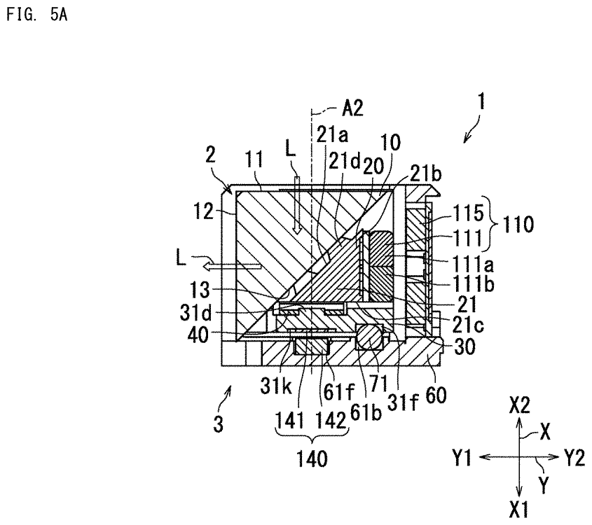

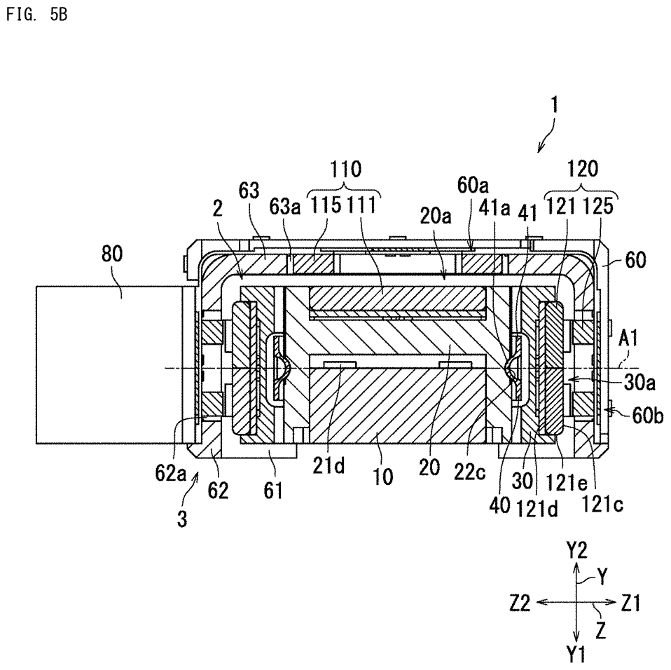

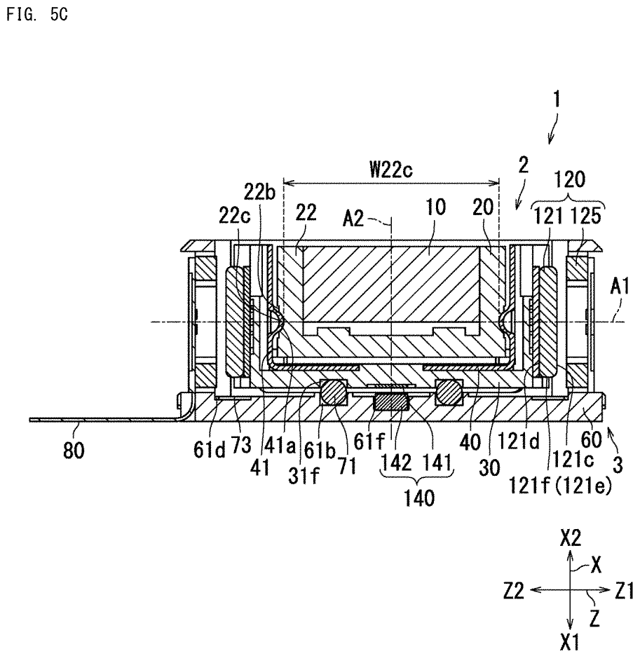

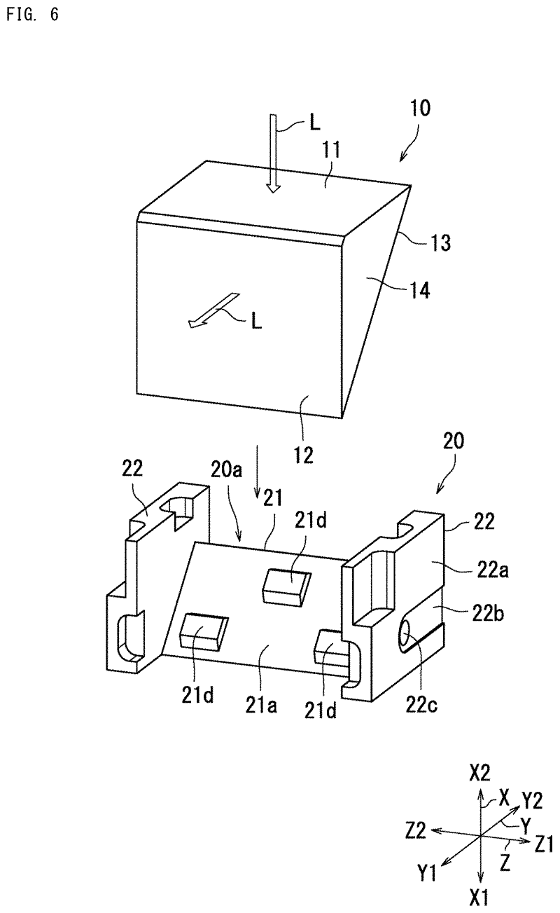

FIG. 5A is a cross-sectional view taken along line VA-VA of FIG. 2. FIG. 5B is a cross-sectional view taken along line VB-VB of FIG. 2. FIG. 5C is a cross-sectional view taken along line VC-VC of FIG. 2. FIG. 6 is an exploded perspective view of the optical element 10 and the holder 20 of the optical unit 1 according to the present embodiment. As shown in FIGS. 5A to 5C and 6, the optical element 10 is composed of a prism. The prism is made from a transparent material having a refractive index higher than that of air. The optical element 10 has a substantially triangular prism shape. Specifically, the optical element 10 has a light incident surface 11, a light exit surface 12, a reflection surface 13, and a pair of side surfaces 14. The light L is incident on the light incident surface 11. The light exit surface 12 is connected to the light incident surface 11. The light exit surface 12 is disposed perpendicular to the light incident surface 11. The reflection surface 13 is connected to the light incident surface 11 and the light exit surface 12. The reflection surface 13 is inclined by about 45 degrees with respect to each of the light incident surface 11 and the light exit surface 12. The reflection surface 13 reflects the light L incident from the light incident surface 11 and traveling to the first side X1 in the first direction X to the first side Y1 in the second direction Y intersecting the first direction X. A pair of the side surfaces 14 is connected to the light incident surface 11, the light exit surface 12, and the reflection surface 13.

The holder 20 is made from, for example, resin. The holder 20 includes a holder body 21 and a pair of side surface portions 22. The holder 20 includes a pair of facing side surfaces 22a, a groove 22b, and an on-axis recess 22c.

Specifically, the holder body 21 has a facing surface 21a and at least three support protrusions 21d. In the present embodiment, the holder body 21 has three of the support protrusions 21d. The facing surface 21a faces the optical element 10. The facing surface 21a is inclined by about 45 degrees with respect to an incident direction of the light L. The incident direction of the light L is a direction toward the first side X1 of the first direction X. The support protrusion 21d is disposed on the facing surface 21a. The support protrusion 21d protrudes from the facing surface 21a toward the optical element 10. The support protrusion 21d contacts the reflection surface 13 of the optical element 10 to support the optical element 10. Therefore, the optical element 10 is supported by the holder 20 on three of the support protrusions 21d. Thus, the optical element 10 can be stably supported by the holder 20 compared to a case where the optical element 10 is supported by four or more points.

Further, the holder body 21 has a back surface 21b and a lower surface 21c. The back surface 21b is connected to an end portion on the opposite side to an emission direction of the light L of the facing surface 21a. Note that the “emission direction of the light L” is the first side Y1 of the second direction Y. Further, the “end portion on the opposite side to an emission direction of the light L” is an end portion on the second side Y2 in the second direction Y. The lower surface 21c is connected to the facing surface 21a and the back surface 21b.

A pair of the side surface portions 22 is disposed at both ends in the third direction Z of the holder body 21. A pair of the side surface portions 22 has shapes symmetrical to each other in the third direction Z. A pair of the facing side surfaces 22a is disposed on each of a pair of the side surface portions 22. A pair of the facing side surfaces 22a faces a pair of side surface portions 41 of the first preload unit 40. A detailed structure of the side surface portion 41 will be described later. The groove 22b is disposed on the facing side surface 22a. The groove 22b is recessed toward the inner side of the holder 20. The groove 22b extends to the second side Y2 in the second direction Y. The on-axis recess 22c is disposed inside the groove 22b. The on-axis recess 22c is recessed toward the inner side of the holder 20 on the first swing axis A1. The on-axis recess 22c houses at least a part of an on-axis protrusion 41a of the first preload unit 40. A detailed structure of the on-axis protrusion 41a will be described later. The on-axis recess 22c has at least a part of a concave spherical surface.

The first preload unit 40 is disposed on at least one of the holder 20 and the first support portion 30. The first preload unit 40 applies a preload to at least the other of the holder 20 and the first support portion 30 in an axial direction of the first swing axis A1. Therefore, the holder 20 can be prevented from being displaced in the axial direction of the first swing axis A1. The axial direction of the first swing axis A1 is a direction along the third direction. Note that, in the present specification and claims, “to apply a preload” means to apply a load in advance.

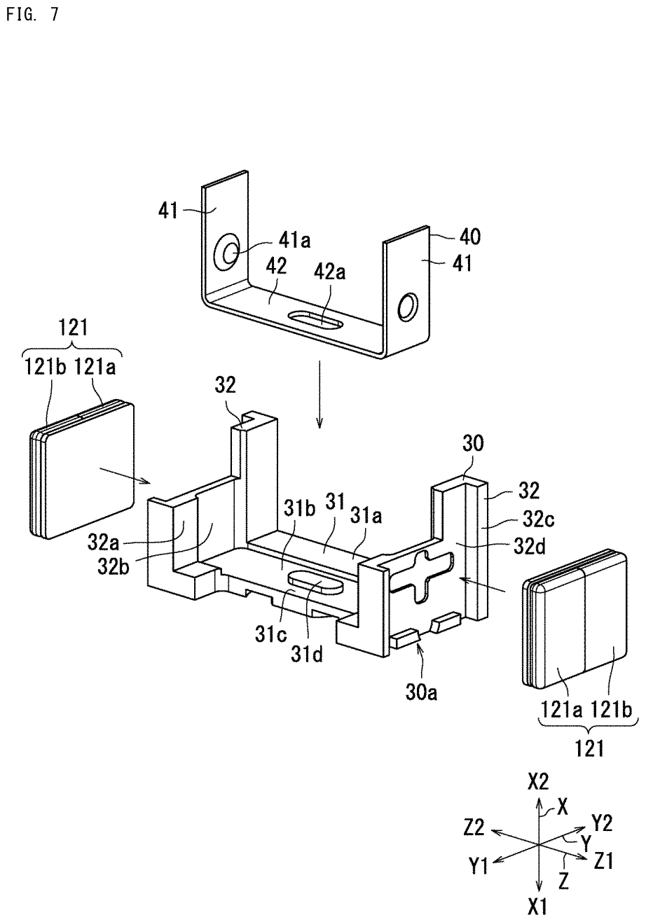

FIG. 7 is an exploded perspective view of the first preload unit 40, the first support portion 30, and a second magnet 121 of the optical unit 1 according to the present embodiment. In the present embodiment, as illustrated in FIGS. 5C and 7, the first preload unit 40 is composed of one member. The first preload unit 40 is disposed on the first support portion 30. The first preload unit 40 includes a pair of the side surface portions 41 and a connection portion 42 that connects a pair of the side surface portions 41 to each other. A pair of the side surface portions 41 has shapes symmetrical to each other in the third direction Z. A pair of the side surface portions 41 sandwiches the holder 20 in the axial direction of the first swing axis A1. Therefore, with a simple configuration, a preload can be applied to the holder 20 in the axial direction of the first swing axis A1.

The side surface portion 41 has the on-axis protrusion 41a. The on-axis protrusion 41a protrudes toward the holder 20 on the first swing axis A1. The on-axis protrusion 41a has at least a part of a spherical surface. A part of the on-axis protrusion 41a is housed in the on-axis recess 22c. Therefore, since the on-axis protrusion 41a and the on-axis recess 22c are in point contact with each other, the holder 20 can be stably supported by the first preload unit 40. Further, a pair of the on-axis protrusions 41a of the first preload unit 40 sandwiches a pair of the on-axis recesses 22c of the holder 20 in the third direction Z. The holder 20 is supported by the first preload unit 40 at two contacts in contact with the on-axis protrusion 41a. Therefore, the holder 20 can swing about the first swing axis A1 passing through the two contacts.

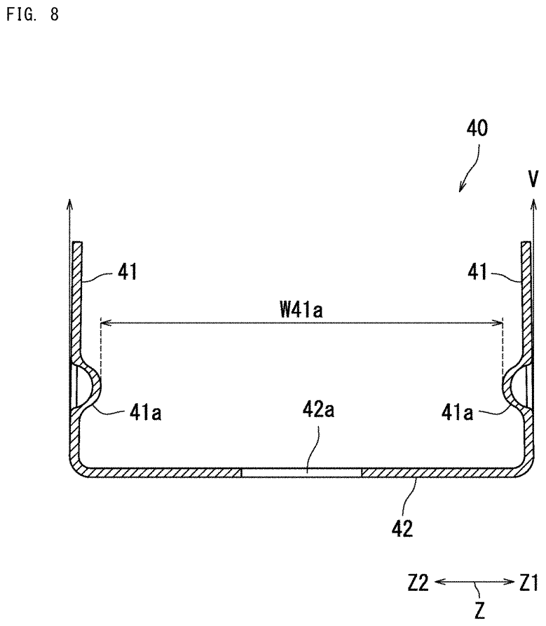

FIG. 8 is a cross-sectional view of the first preload unit 40 of the optical unit 1 according to the present embodiment. As illustrated in FIG. 8, in a state where the first preload unit 40 is not attached to the holder 20, a pair of the side surface portions 41 is inclined inward with respect to a direction V perpendicular to the connection portion 42. A distance between a pair of the side surface portions 41 is smaller at a position where a distance from the connection portion 42 is farther. Therefore, a larger preload can be applied to the holder 20 in the axial direction of the first swing axis A1 as compared with a case where the distance between a pair of the side surface portions 41 is larger at a position where a distance from the connection portion 42 is farther and a case where the distance between a pair of the side surface portions 41 is the same. Further, in the state where the first preload unit 40 is not attached to the holder 20, a distance W41a between the on-axis protrusions 41a is smaller than a distance W22c (see FIG. 5C) between the on-axis recesses 22c of the holder 20.

A pair of the side surface portions 41 and the connection portion 42 are composed of a single member. The first preload unit 40 can be attached to the holder 20 by pushing and spreading a pair of the side surface portions 41 outward. That is, the first preload unit 40 can be attached to the holder 20 by pushing and spreading a pair of the side surface portions 41 to the first side Z1 and the second side Z2 in the third direction Z. In the present embodiment, since the holder 20 has the groove 22b (see FIG. 6), the first preload unit 40 can be easily attached to the holder 20 by moving the on-axis protrusion 41a along the groove 22b. The first preload unit 40 is preferably made from metal. The first preload unit 40 may be made from resin.

As illustrated in FIG. 7, the connection portion 42 has a fitting hole 42a to be fitted to a fitting protrusion 31d of the first support portion 30. The fitting hole 42a is disposed at the center of the connection portion 42 in the third direction Z. In the present embodiment, the fitting hole 42a is provided to fix the first preload unit 40 to the first support portion 30.

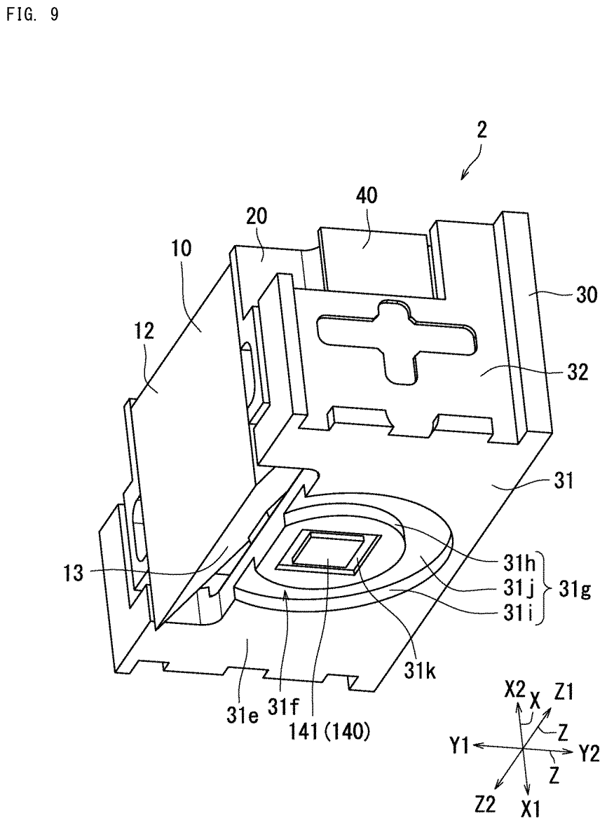

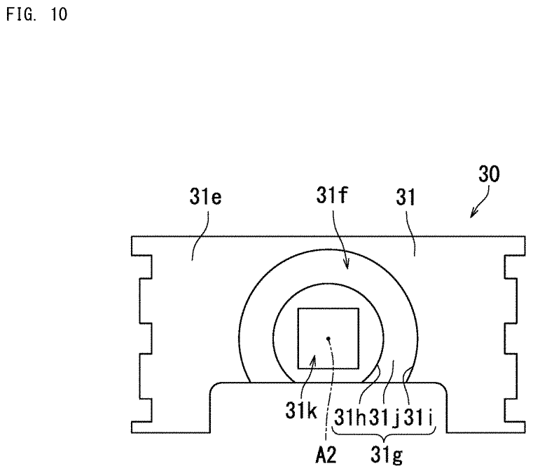

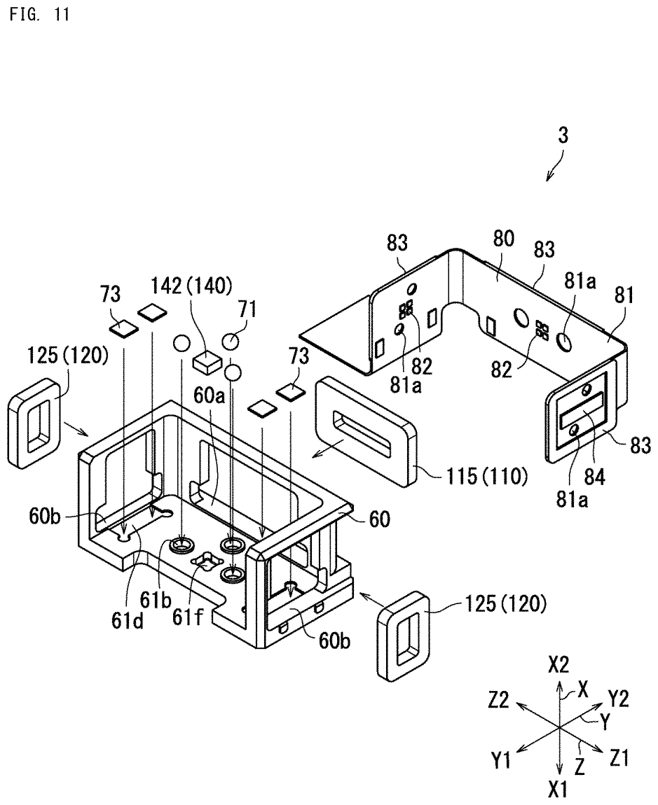

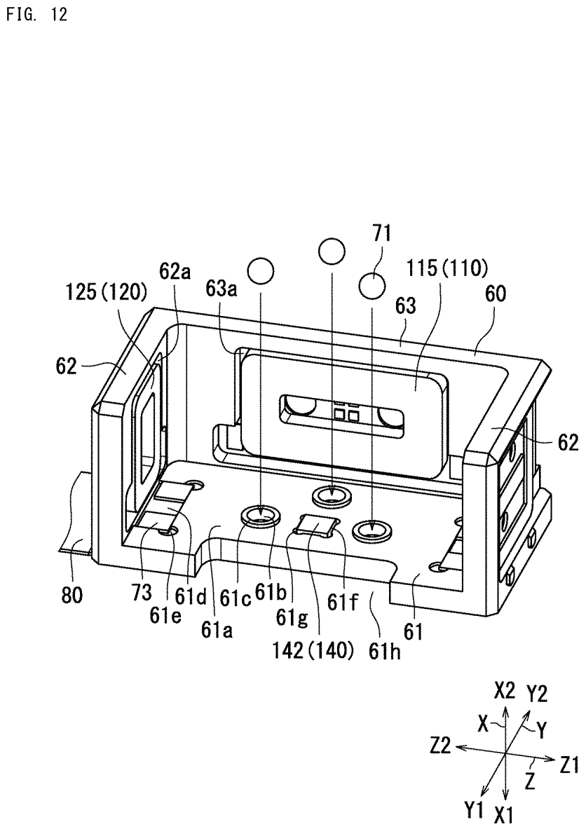

FIG. 9 is a perspective view illustrating the movable body 2 of the optical unit 1 according to the present embodiment. FIG. 10 is a diagram illustrating the first support portion 30 of the optical unit 1 according to the present embodiment from the first side X1 in the first direction X. FIG. 11 is an exploded perspective view of the support 3 of the optical unit 1 according to the present embodiment. FIG. 12 is a perspective view illustrating a periphery of the second support portion 60 of the optical unit 1 according to the present embodiment. As illustrated in FIGS. 9 to 12, one of the movable body 2 and the support 3 has at least three axial center protrusions 71 protruding toward the other of the movable body 2 and the support 3. Specifically, one of the first support portion 30 and the second support portion 60 has at least three of the axial center protrusions 71 protruding toward the other of the first support portion 30 and the second support portion 60. In the present embodiment, the number of the axial center protrusions 71 is three. Therefore, since the movable body 2 is supported by three of the axial center protrusions 71, the movable body 2 can be stably supported as compared with a case where the movable body 2 is supported by four or more of the axial center protrusions 71. Note that the axial center protrusion 71 is an example of the “protrusion” in the present disclosure.

The other of the movable body 2 and the support 3 has an axial center recess 31f recessed in the opposite direction to the axial center protrusion 71. The axial center recess 31f is in contact with the axial center protrusion 71. Further, the axial center recess 31f constitutes at least a part of a circle around the second swing axis A2. Therefore, at least three of the axial center protrusions 71 move along an inner surface 31g of the axial center recess 31f. Therefore, the movable body 2 can be stably swung with respect to the support 3 about the second swing axis A2. As a result, the correction accuracy of the optical unit 1 can be improved. Specifically, the other of the first support portion 30 and the second support portion 60 has the axial center recess 31f recessed in the opposite direction to the axial center protrusion 71. Note that the axial center recess 31f is an example of the “recess” in the present disclosure.

Further, in the present embodiment, the movable body 2 has the axial center recess 31f, and the support 3 has the axial center protrusion 71. Therefore, in a case where the axial center protrusion 71 is a sphere, the movable body 2 can be assembled to the support 3 in a state where the sphere is arranged on the second support portion 60, so that the assembly work can be facilitated. More specifically, the first support portion 30 has the axial center recess 31f, and the second support portion 60 has the axial center protrusion 71.

As illustrated in FIGS. 7 and 9, the first support portion 30 includes a support body 31 and a pair of side surface portions 32. The support body 31 includes an upper facing surface 31a, a recess 31b, and the fitting protrusion 31d. The upper facing surface 31a faces the holder 20 in the first direction X. The recess 31b is disposed on the upper facing surface 31a. The recess 31b is slightly larger than the connection portion 42 of the first preload unit 40. The recess 31b houses the connection portion 42. The recess 31b has a bottom surface 31c. The fitting protrusion 31d is disposed on the bottom surface 31c. The fitting protrusion 31d protrudes from the bottom surface 31c toward the holder 20. The connection portion 42 of the first preload unit 40 is disposed on the bottom surface 31c. The fitting protrusion 31d has a shape extending along the first swing axis A1. The fitting protrusion 31d has, for example, an oval shape or a rectangular shape. The fitting protrusion 31d is disposed in the fitting hole 42a and is fitted into the fitting hole 42a. Therefore, by fitting the fitting hole 42a of the connection portion 42 to the fitting protrusion 31d of the first support portion 30, the first preload unit 40 can be fixed to the first support portion 30. Note that, in the present embodiment, the first support portion 30 has the fitting protrusion 31d, and the connection portion 42 has the fitting hole 42a. However, the first support portion 30 may have a fitting hole, and the connection portion 42 may have a fitting protrusion. Further, in the present embodiment, the first support portion 30 and the first preload unit 40 are fixed by fitting. However, the first support portion 30 and the first preload unit 40 may be fixed by a method other than fitting. For example, the first support portion 30 and the first preload unit 40 may be fixed by an adhesive. Further, the first support portion 30 and the first preload unit 40 may be integrally formed by insert molding or the like.

A pair of the side surface portions 32 is disposed at both ends in the third direction Z of the support body 31. A pair of the side surface portions 32 has shapes symmetrical to each other in the third direction Z. The side surface portion 32 has an inner side surface 32a and a recess 32b. The inner side surface 32a faces the holder 20 in the third direction Z. The recess 32b is disposed on the inner side surface 32a. The recess 32b houses a part of the side surface portion 41 of the first preload unit 40.

Further, the side surface portion 32 has an outer side surface 32c and a housing recess 32d. The outer side surface 32c faces the outer side in the third direction Z. The housing recess 32d is disposed on the outer side surface 32c. The housing recess 32d houses at least a part of the second magnet 121 of the second swing mechanism 120.

Further, the support body 31 includes a lower facing surface 31e and the axial center recess 31f. The lower facing surface 31e faces the support 3 in the first direction X. Note that the lower facing surface 31e is an example of the “facing surface” of the present disclosure. More specifically, the lower facing surface 31e faces the second support portion 60 of the support 3 in the first direction X. The axial center recess 31f is disposed on the lower facing surface 31e. The axial center recess 31f is disposed on the first side X1 in the first direction X with respect to the reflection surface 13 of the optical element 10. Therefore, the axial center recess 31f can be disposed without blocking an optical path.

As described above, the axial center recess 31f constitutes at least a part of a circle around the second swing axis A2. The axial center recess 31f has a shape in which an end portion on the first side Y1 in the second direction Y of a circle around the second swing axis A2 is cut out. A part of the reflection surface 13 protrudes toward the first side X1 in the first direction X and the first side Y1 in the second direction Y with respect to the lower facing surface 31e. Therefore, it is possible to prevent the optical element 10 from coming into contact with a portion of the first support portion 30 where the axial center recess 31f is disposed. That is, a space for disposing the optical element 10 can be secured. Note that, in the present specification and the claims, the “circle” includes a “circumference” and also includes the “inside surrounded by the circumference”.

Further, as shown in FIGS. 9 and 10, the axial center recess 31f preferably constitutes at least a part of the circumference around the second swing axis A2. That is, the inner surface 31g of the axial center recess 31f preferably has an inner side surface 31h on the radially inner side with respect to the second swing axis A2, an inner side surface 31i on the radially outer side, and a connection surface 31j. The connection surface 31j connects the inner side surface 31h and the inner side surface 31i. The inner surface 31g of the axial center recess 31f comes into contact with the axial center protrusion 71. Therefore, the axial center protrusion 71 can be held by the inner side surface 31i and the inner side surface 31h of the axial center recess 31f. Therefore, the movable body 2 can be more stably swung with respect to the support 3 as compared with a case where the axial center recess 31f does not have the inner side surface 31h. Note that the axial center recess 31f does not need to have the inner side surface 31h. In other words, the entire region surrounded by the inner side surface 31i may be recessed to the second side X2 in the first direction X.

Further, the support body 31 preferably has a housing recess 31k. The housing recess 31k houses a magnetic member 141 of the second preload unit 140.

As illustrated in FIGS. 11 and 12, the support 3 includes the second support portion 60, the axial center protrusion 71, and a magnetic member 73. The support 3 preferably has a facing surface 61a and a housing recess 61d.

Specifically, the second support portion 60 supports the first support portion 30 in a manner that the first support portion 30 is swingable about the second swing axis A2. Further, the second support portion 60 supports the first support portion 30 in the first direction X. Therefore, the first support portion 30 can be easily swung about the second swing axis A2 extending along the first direction X.

The second support portion 60 includes a support body 61, a pair of side surface portions 62, and a back surface portion 63. The support body 61 includes a facing surface 61a, at least three housing recesses 61b, at least three circular protrusions 61c, a plurality of housing recesses 61d, and a housing recess 61f. In the present embodiment, the support body 61 has three of the housing recesses 61b, three of the circular protrusions 61c, and two of the housing recesses 61d. The housing recess 61b is an example of the “housing recess” of the present disclosure. Note that, in the present embodiment, an example in which the second support portion 60 has the housing recess 61b will be described. However, one of the movable body 2 and the support 3 may have at least three housing recesses recessed in the opposite direction to the other of the movable body 2 and the support 3.

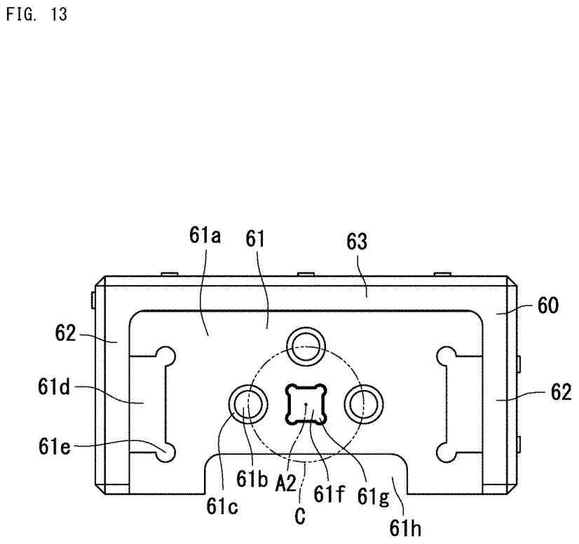

The facing surface 61a faces the lower facing surface 31e of the first support portion 30 in the first direction X. The housing recess 61b, the circular protrusion 61c, the housing recess 61d, and the housing recess 61f are disposed on the facing surface 61a. The housing recess 61b, the housing recess 61d, and the housing recess 61f are recessed in the opposite direction to the movable body 2 in the first direction X. That is, the housing recess 61b, the housing recess 61d, and the housing recess 61f are recessed to the first side X1 in the first direction X. The housing recess 61b faces the axial center recess 31f of the first support portion 30 in the first direction X. That is, the housing recess 61b is disposed on the same circumference C (see FIG. 13) around the second swing axis A2. The housing recess 61b houses a part of the axial center protrusion 71. Therefore, at least three of the axial center protrusions 71 are arranged on the same circumference C around the second swing axis A2. The axial center protrusion 71 protrudes in the axial direction of the second swing axis A2. Therefore, at least three of the axial center protrusions 71 protruding in the axial direction of the second swing axis A2 come into contact with the movable body 2. Therefore, the movable body 2 can be swung with respect to the support 3 more stably. Note that the axial direction of the second swing axis A2 is a direction along the first direction X.

Further, one of the housing recesses 61b is disposed at a position farthest from the optical element 10 on the same circumference. In contrast, two of the housing recesses 61b are arranged at positions closer to the optical element 10 than one of the housing recesses 61b described above in a state of being arranged in the third direction Z.

The housing recess 61b holds a part of the axial center protrusion 71. The circular protrusion 61c protrudes toward the first support portion 30. Since the circular protrusion 61c protrudes from the facing surface 61a, the depth of the housing recess 61b can be made large. In the present embodiment, the lower half of the axial center protrusion 71 is disposed in the housing recess 61b. The axial center protrusion 71 has at least a part of a spherical surface. Therefore, since the axial center protrusion 71 comes into point contact with the axial center recess 31f, the movable body 2 can be smoothly moved with respect to the support 3. In the present embodiment, the axial center protrusion 71 is a sphere. The axial center protrusion 71 is rotatable in the housing recess 61b. Therefore, since the friction between the axial center protrusion 71 and the axial center recess 31f of the first support portion 30 is rolling friction, the effect of rolling friction can also be obtained.

Further, a material of the axial center protrusion 71 is ceramic. Therefore, the axial center protrusion 71, which is non-magnetic, is not affected by a magnet. Further, wear of the axial center protrusion 71 can be suppressed. Note that the material of the axial center protrusion 71 may be metal. Also in this case, wear of the axial center protrusion 71 can be suppressed. Further, the configuration may be such that the entire axial center protrusion 71 is made from metal, or only the surface of the axial center protrusion 71 is made from metal by plating, for example.

Further, at least three of the axial center protrusions 71 are arranged in a manner separated from each other on the same circumference C around the second swing axis A2. Therefore, for example, as compared with a case where three of the axial center protrusions 71 are not separated, the movable body 2 can be supported over a wider range.

Further, at least three of the axial center protrusions 71 are disposed at at least three predetermined positions on the same circumference C around the second swing axis A2. Therefore, the position of the axial center protrusion 71 does not move with respect to one of the movable body 2 and the support 3. Therefore, the movable body 2 can be swung with respect to the support 3 more stably. In the present embodiment, the position of the axial center protrusion 71 does not move with respect to the support 3.

Further, two of the axial center protrusions 71 are arranged side by side in the third direction Z. The remaining axial center protrusion 71 is disposed on the circumference C having two of the axial center protrusions 71 as both ends of the diameter. Therefore, it is possible to suppress the contact of the optical element 10 with the axial center protrusion 71. That is, a space for disposing the optical element 10 can be secured.

Further, a triangle having the two axial center protrusions 71 and the remaining axial center protrusion 71 as vertices is a right triangle. The inner angle of the remaining axial center protrusion 71 is about 90 degrees.

Further, the axial center protrusion 71 is disposed on the first side X1 in the first direction X with respect to the reflection surface 13 of the optical element 10. Therefore, the axial center protrusion 71 can be disposed without blocking an optical path.

The housing recess 61d faces the second magnet 121 of the second swing mechanism 120. The housing recess 61d houses the magnetic member 73. The housing recess 61d has a substantially rectangular shape. The magnetic member 73 has a rectangular shape. The housing recess 61d has an expansion portion 61e that expands in a direction away from a corner portion of the magnetic member 73. Therefore, it is possible to prevent the corner portion of the magnetic member 73 from coming into contact with an inner side surface of the housing recess 61d. Therefore, it is possible to suppress chipping of the corner portion of the magnetic member 73.

The magnetic member 73 is a plate-like member composed of a magnetic material. The magnetic member 73 is disposed on the first side X1 in the first direction X with respect to the second magnet 121. Since a force (hereinafter, also referred to as attractive force) attracting each other acts on the second magnet 121 and the magnetic member 73, the movable body 2 can be prevented from being displaced in the first direction X with respect to the support 3. Further, since the second magnet 121 of the second swing mechanism 120 is used, it is possible to suppress an increase in the number of components. Note that the action of preventing the movable body 2 from being displaced in the first direction X with respect to the support 3 is similar to the action of the magnetic member 141 and a third magnet 142 of the second preload unit 140 as described later. Therefore, the magnetic member 141 and the third magnet 142 of the second preload unit 140 can be downsized.

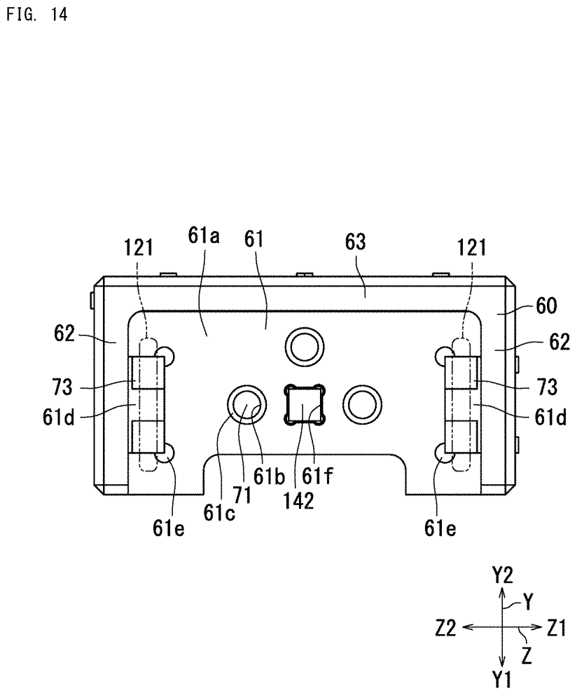

FIG. 14 is a diagram illustrating the second support portion 60, the axial center protrusion 71, the second magnet 121, and the third magnet 142 of the optical unit 1 according to the present embodiment from the second side X2 in the first direction X. As illustrated in FIGS. 5C and 14, the second magnet 121 and the magnetic member 73 overlap each other when viewed from a direction perpendicular to a direction in which the second magnet 121 and the second coil 125 face each other. In the present embodiment, the second magnet 121 and the magnetic member 73 overlap when viewed from the first direction X. That is, the magnetic member 73 is disposed on the first side X1 in the first direction X with respect to a surface 121f on the first side X1 in the first direction X of a peripheral surface 121e of the second magnet 121. The surface 121f is a lower surface of the magnetic member 73. A detailed structure of the second magnet 121 will be described later.

In the present embodiment, two of the magnetic members 73 are disposed in each of the housing recess 61d. In other words, the magnetic members 73 are arranged to be separated in the polarized direction of the second magnet 121 of the second swing mechanism 120. Therefore, the area of the second magnet 121 is smaller than that in a case where the second magnets 121 are not separated. Note that, as illustrated in FIG. 7, the second magnet 121 is polarized in the second direction Y. Here, when the movable body 2 is swung by the second swing mechanism 120, a force acts on the movable body 2 in a direction of returning to a reference position by the attractive force between the second magnet 121 and the magnetic member 73. As illustrated in FIG. 5B, the reference position is a position where the side surface portion 32 of first support portion 30 and the side surface portion 62 of the second support portion 60 are parallel to each other. The force acting on the movable body 2 in the direction of returning to the reference position becomes lower as the area of the magnetic member 73 is smaller. Therefore, when the movable body 2 is swung by the second swing mechanism 120, a magnetic force acting on the movable body 2 in the direction of returning to the reference position can be reduced.

The housing recess 61f is disposed on the second swing axis A2. The housing recess 61f houses the third magnet 142 of the second preload unit 140 of the first support portion 30. Therefore, the third magnet 142 faces the magnetic member 141 of the second preload unit 140 in the first direction X. The housing recess 61f has a substantially rectangular shape. The third magnet 142 has a rectangular shape. The housing recess 61f has an expansion portion 61g. The expansion portion 61g expands in a direction away from a corner portion of the third magnet 142. Therefore, it is possible to prevent the corner portion of the third magnet 142 from coming into contact with an inner side surface of the housing recess 61f. Therefore, it is possible to suppress chipping of the corner portion of the third magnet 142.

As illustrated in FIGS. 12 and 14, a pair of the side surface portions 62 is disposed at both ends in the third direction Z of the support body 61. A pair of the side surface portions 62 has shapes symmetrical to each other in the third direction Z. The side surface portion 62 has a housing hole 62a in which the second coil 125 of the second swing mechanism 120 is disposed. The housing hole 62a penetrates the side surface portion 62 in a thickness direction. That is, the housing hole 62a penetrates the side surface portion 62 in the third direction Z.

The back surface portion 63 is disposed in an end portion on the second side Y2 in the second direction Y of the support body 61. The back surface portion 63 has a housing hole 63a in which a first coil 115 of the first swing mechanism 110 is disposed. The housing hole 63a penetrates the back surface portion 63 in a thickness direction. That is, the housing hole 63a penetrates the back surface portion 63 in the second direction Y.

The FPC 80 is disposed so as to cover the outer side of a pair of the side surface portions 62 and the outer side of the back surface portion 63. The FPC 80 includes, for example, a semiconductor element, a connection terminal, and a wiring. The FPC 80 supplies power to the first coil 115 of the first swing mechanism 110 and the second coil 125 of the second swing mechanism 120 at a predetermined timing.

Specifically, as illustrated in FIG. 11, the FPC 80 includes a substrate 81, a connection terminal 82, a reinforcing plate 83, and a magnetic member 84. The substrate 81 is composed of, for example, a polyimide substrate. The substrate 81 has flexibility. The substrate 81 has a plurality of pin insertion holes 81a. The pin insertion hole 81a faces the first coil 115 and the second coil 125. A coil pin of the first coil 115 or a coil pin (not illustrated) of the second coil 125 is disposed in each of the pin insertion holes 81a.

The connection terminal 82 is disposed on the substrate 81. The connection terminal 82 faces the first swing mechanism 110 and the second swing mechanism 120. The connection terminal 82 is electrically connected to a terminal of a Hall element (not illustrated). Note that, for example, four of the connection terminals 82 are disposed for one Hall element. Three of the reinforcing plates 83 are disposed on the substrate 81. The reinforcing plate 83 faces the first swing mechanism 110 and the second swing mechanism 120. The reinforcing plate 83 suppresses bending of the substrate 81.

Three of the magnetic members 84 are disposed on the substrate 81. Two of the magnetic members 84 face the second magnet 121 of the second swing mechanism 120. In a state where the second coil 125 is not energized, an attractive force is generated between the second magnet 121 and the magnetic member 84. Therefore, the movable body 2 is disposed at the reference position in the rotation direction around the second swing axis A2. Further, the remaining one of the magnetic members 84 faces a first magnet 111 of the first swing mechanism 110. In a state where the first coil 115 is not energized, an attractive force is generated between the first magnet 111 and the magnetic member 84. Therefore, the movable body 2 is disposed at the reference position in the rotation direction around the first swing axis A1. Note that the reference position will be described later.

As illustrated in FIGS. 5A to 5C, the first swing mechanism 110 swings the holder 20 with respect to the first support portion 30 about the first swing axis A1. The first swing mechanism 110 includes the first magnet 111 and the first coil 115. The first coil 115 faces the first magnet 111 in the second direction Y.

The first magnet 111 is disposed on one of the holder 20 and the second support portion 60. In contrast, the first coil 115 is disposed on the other of the holder 20 and the second support portion 60. In the present embodiment, the first magnet 111 is disposed on the holder 20. The first coil 115 is disposed on the second support portion 60. Therefore, a force acts on the first magnet 111 due to a magnetic field generated when current flows through the first coil 115. Then, the holder 20 swings with respect to the first support portion 30. Therefore, the holder 20 can be swung with a simple configuration using the first magnet 111 and the first coil 115. Further, by disposing the first coil 115 on the second support portion 60, the first coil 115 does not swing with respect to the second support portion 60. Therefore, wiring can be easily performed on the first coil 115 as compared with a case where the first coil 115 is disposed on the first support portion 30, for example.

Specifically, the first magnet 111 is disposed on the back surface 21b of holder 20. That is, the first magnet 111 is disposed in an end portion 20a on the second side Y2 in the second direction Y of the holder 20. The first magnet 111 includes an n-pole portion 111a including an n-pole and an s-pole portion 111b including an s-pole. The first magnet 111 is polarized in the first direction X.

The first coil 115 is disposed in the housing hole 63a of the back surface portion 63 of the second support portion 60. That is, the first coil 115 is disposed in an end portion 60a on the second side Y2 in the second direction Y of the second support portion 60. Therefore, it is possible to prevent the first coil 115 and the first magnet 111 from being disposed on an optical path. Therefore, it is possible to prevent the optical path from being blocked by the first coil 115 and the first magnet 111.

When the first coil 115 is energized, a magnetic field is generated around the first coil 115. Then, a force caused by a magnetic field acts on the first magnet 111. As a result, the holder 20 and the optical element 10 swing with respect to the first support portion 30 and the second support portion 60 about the first swing axis A1.

Further, by disposing the first magnet 111 and the first coil 115 of the first swing mechanism 110 along the second direction Y, the first magnet 111 and the first coil 115 attract each other in the second direction Y. Therefore, it is possible to prevent the holder 20 from coming off to the first side Y1 in the second direction Y by the force by which the first magnet 111 and the first coil 115 attract each other in the second direction Y.

The second swing mechanism 120 swings the movable body 2 about the second swing axis A2. Specifically, the second swing mechanism 120 swings the first support portion 30 with respect to the second support portion 60 about the second swing axis A2. The second swing mechanism 120 includes the second magnet 121 and the second coil 125. The second magnet 121 is disposed on one of the first support portion 30 and the second support portion 60. In contrast, the second coil 125 is disposed on the other of the first support portion 30 and the second support portion 60. In the present embodiment, the second magnet 121 is disposed on the first support portion 30. The second coil 125 is disposed on the second support portion 60. Therefore, the first support portion 30 swings with respect to the second support portion 60 by a magnetic field generated when current flows through the second coil 125. Therefore, the first support portion 30 can be swung with a simple configuration using the second magnet 121 and the second coil 125. Further, by disposing the second coil 125 on the second support portion 60, the second coil 125 does not swing with respect to the second support portion 60. Therefore, wiring can be easily performed on the second coil 125 as compared with a case where the second coil 125 is disposed on the first support portion 30, for example.

Specifically, the second magnet 121 is disposed in the housing recess 32d (see FIG. 7) of the side surface portion 32 of the first support portion 30. That is, the second magnet 121 is disposed on an end portion 30a in a direction intersecting the first direction X of the first support portion 30. In the present embodiment, the second magnet 121 is disposed in the end portion 30a in the third direction Z. The second magnet 121 includes an n-pole portion 121a including an n-pole and an s-pole portion 121b including an s-pole. The second magnet 121 is polarized in the second direction Y intersecting the first direction X. Therefore, the movable body 2 can be swung about the second swing axis A2 along an incident direction of light.

Further, the second magnet 121 has a coil facing surface 121c, an inner side surface 121d, and the peripheral surface 121e. The coil facing surface 121c faces the second coil 125. The inner side surface 121d is disposed on the side opposite to the coil facing surface 121c. The peripheral surface 121e is connected to the coil facing surface 121c. The peripheral surface 121e is also connected to the inner side surface 121d. The peripheral surface 121e is disposed over one circumference around the coil facing surface 121c and the inner side surface 121d.

The second coil 125 faces the second magnet 121 in the third direction Z. The second coil 125 is disposed in the housing hole 62a (see FIG. 12) of the side surface portion 62 of the second support portion 60. That is, the second coil 125 is disposed in an end portion 60b in the third direction Z of the second support portion 60.

When the second coil 125 is energized, a magnetic field is generated around the second coil 125. Then, a force caused by the magnetic field acts on the second magnet 121. As a result, the first support portion 30, the holder 20, and the optical element 10 swing with respect to the second support portion 60 about the second swing axis A2.

Note that, in a case where the optical unit 1 is used for the smartphone 200 as illustrated in FIG. 1, a Hall element (not illustrated) in the smartphone 200 detects the posture of the smartphone 200. Then, the first swing mechanism 110 and the second swing mechanism 120 are controlled according to the posture of the smartphone 200. Further, it is preferable that the posture of the holder 20 with respect to the second support portion 60 be detectable. In this case, the posture of the holder 20 with respect to the second support portion 60 can be controlled with high accuracy. Note that, for example, a gyro sensor may be used as a sensor that detects the posture of the smartphone 200.

The second preload unit 140 is disposed on at least one of the movable body 2 and the support 3. The second preload unit 140 applies a preload to at least the other of the movable body 2 and the support 3 in the axial direction of the second swing axis A2. Therefore, the movable body 2 can be prevented from being displaced in the axial direction of the second swing axis A2 with respect to the support 3. In the present embodiment, the second preload unit 140 is disposed on at least one of the first support portion 30 and the second support portion 60. The second preload unit 140 applies a preload to at least the other of the first support portion 30 and the second support portion 60 in the axial direction of the second swing axis A2. Therefore, the first support portion 30 can be prevented from being displaced in the axial direction of the second swing axis A2 with respect to the second support portion 60.

Specifically, the second preload unit 140 includes the magnetic member 141 and the third magnet 142. The third magnet 142 is disposed on one of the movable body 2 and the support 3. The magnetic member 141 is disposed on the other of the movable body 2 and the support 3. Therefore, since a force attracting each other acts on the third magnet 142 and the magnetic member 141, a preload can be applied to at least the other of the movable body 2 and the support 3 in the axial direction of the second swing axis A2. Further, with a simple configuration using the third magnet 142 and the magnetic member 141, a preload can be applied to at least the other of the movable body 2 and the support 3 in the axial direction of the second swing axis A2. In the present embodiment, the third magnet 142 is disposed on one of the first support portion 30 and the second support portion 60. The magnetic member 141 is disposed on the other of the first support portion 30 and the second support portion 60. More specifically, the third magnet 142 is disposed on the second support portion 60. The magnetic member 141 is disposed on the first support portion 30. Therefore, a preload can be applied to the first support portion 30 in the axial direction of the second swing axis A2.

The magnetic member 141 is a plate-like member composed of a magnetic material. The magnetic member 141 is disposed on the housing recess 31k of the first support portion 30. The third magnet 142 is disposed on the housing recess 61f of the second support portion 60. The magnetic member 141 faces the third magnet 142 in the first direction X. Therefore, a force attracting each other acts between the magnetic member 141 and the third magnet 142.

The third magnet 142 and the magnetic member 141 are disposed on the second swing axis A2. Therefore, when the movable body 2 swings about the second swing axis A2, it is possible to suppress a change in the positional relationship between the third magnet 142 and the magnetic member 141. Therefore, it is possible to suppress fluctuation of the attractive force between the third magnet 142 and the magnetic member 141.

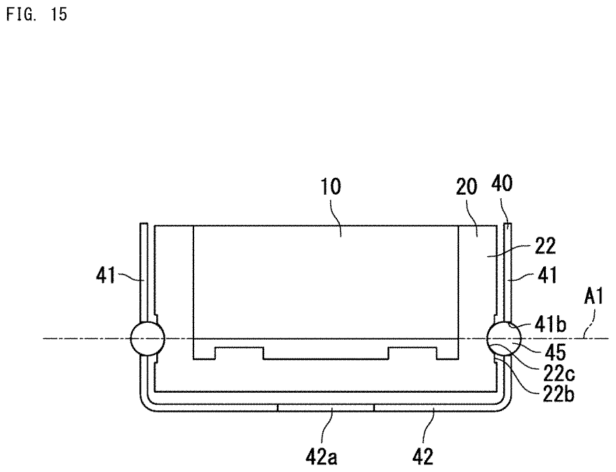

Hereinafter, first to seventh variations of the present embodiment will be described with reference to FIGS. 15 to 22. Hereinafter, a difference from the present embodiment illustrated in FIGS. 1 to 14 will be mainly described.

The first variation of the embodiment of the present disclosure will be described with reference to FIG. 15. In the first variation, a case where an on-axis protrusion 45 of the first preload unit 40 is composed of a sphere will be described. As illustrated in FIG. 15, a pair of the side surface portions 41 of the first preload unit 40 has the on-axis protrusion 45. The on-axis protrusion 45 protrudes toward the holder 20 on the first swing axis A1. The on-axis protrusion 45 is composed of a sphere.

Further, the side surface portion 41 has a through hole 41b. The through hole 41b penetrates the side surface portion 41 in a thickness direction. That is, the through hole 41b penetrates the side surface portion 41 in the third direction Z. The through hole 41b is disposed on the first swing axis A1. The on-axis protrusion 45 is fixed to the through hole 41b. The on-axis protrusion 45 may be fitted into the through hole 41b. Further, the on-axis protrusion 45 may be fixed to the through hole 41b using, for example, an adhesive. A part of the on-axis protrusion 45 is housed in the on-axis recess 22c. The on-axis protrusion 45 and the on-axis recess 22c are in point contact with each other.

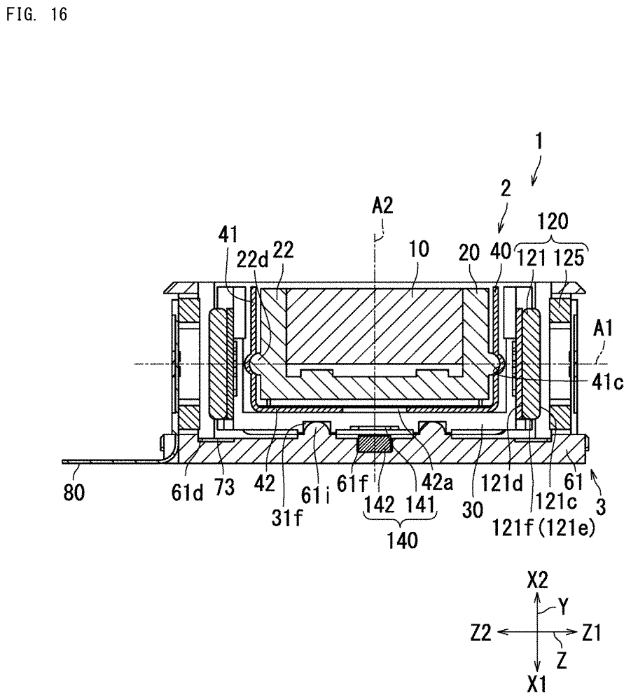

The second variation of the embodiment of the present disclosure will be described with reference to FIG. 16. In the second variation, a case where the holder 20 has an on-axis protrusion 22d will be described. FIG. 16 is a cross-sectional view illustrating the optical unit 1 according to the second variation of the present embodiment. As illustrated in FIG. 16, a pair of the side surface portions 22 of the holder 20 has the on-axis protrusion 22d. The on-axis protrusion 22d protrudes toward the first preload unit 40 on the first swing axis A1. The on-axis protrusion 22d has a part of a spherical surface. The on-axis protrusion 22d has, for example, a hemispherical shape.

A pair of the side surface portions 41 of the first preload unit 40 has an on-axis recess 41c. The on-axis recess 41c is recessed to the opposite side to the holder 20. The on-axis recess 41c is disposed on the first swing axis A1. The on-axis recess 41c has a part of a concave spherical surface. A part of the on-axis protrusion 22d is housed in the on-axis recess 41c. The on-axis protrusion 22d and the on-axis recess 41c are in point contact with each other.

Note that, in the embodiment illustrated in FIGS. 1 to 14, the example in which the axial center protrusion 71 is a sphere and the axial center protrusion 71 is disposed in the housing recess 61b is described. However, the present disclosure is not limited to this example. That is, as shown in FIG. 16, an axial center protrusion 61i may be composed of a single member as the member constituting the support 3. More specifically, the axial center protrusion 61i and the second support portion 60 may be composed of a single member. Further, the axial center protrusion may be composed of a single member as the member constituting the movable body 2. The axial center protrusion 61i may have, for example, a hemispherical shape. Further, the axial center protrusion 61i may have, for example, a shape in which a tip of a cylinder is formed in a hemispherical shape. Note that the axial center protrusion 61i is an example of the “protrusion” in the present disclosure.

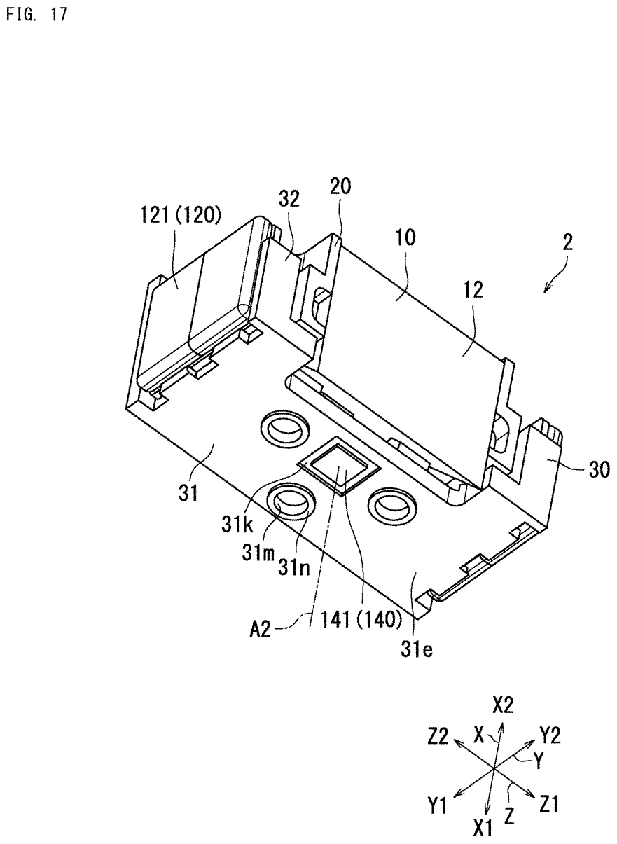

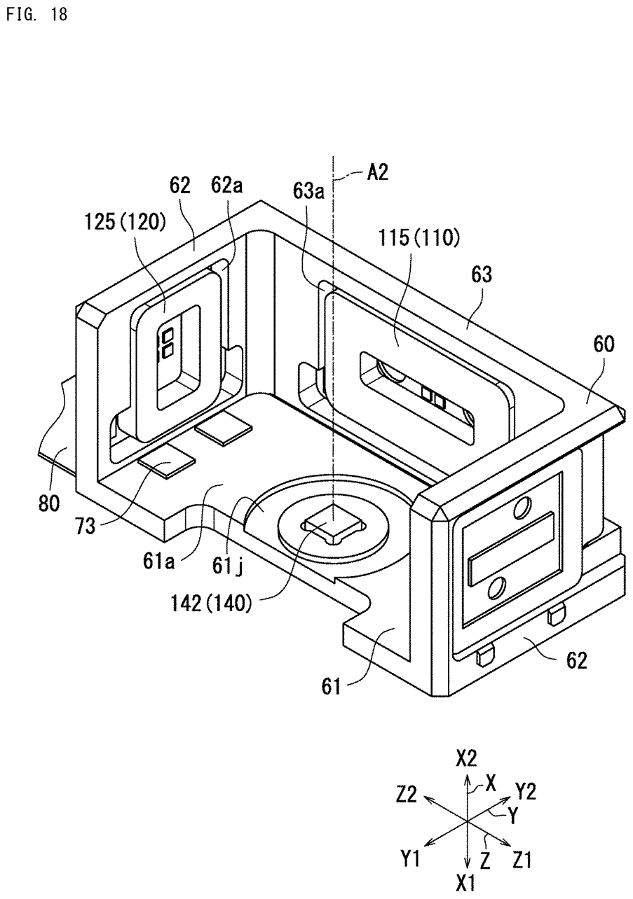

The third variation of the embodiment of the present disclosure will be described with reference to FIGS. 17 and 18. In the third variation, a case where the movable body 2 has the axial center protrusion 71 and the support 3 has an axial center recess 61j will be described. Note that the axial center recess 61j is an example of the “recess” in the present disclosure. FIG. 17 is a perspective view illustrating the movable body 2 of the optical unit 1 according to the third variation of the present embodiment. FIG. 18 is a perspective view illustrating the support 3 of the optical unit 1 according to the third variation of the present embodiment.

As illustrated in FIG. 17, the first support portion 30 has at least three of the axial center protrusions 71 protruding toward the second support portion 60. Specifically, the support body 31 of the first support portion 30 has at least three housing recesses 31m and at least three circular protrusions 31n. In the third variation, the number of each of the axial center protrusions 71, the housing recesses 31m, and the circular protrusions 31n is three. The housing recess 31m and the circular protrusion 31n are disposed on the lower facing surface 31e. The housing recesses 31m are disposed on the same circumference around the second swing axis A2. The housing recess 31m houses a part of the axial center protrusion 71. Therefore, the axial center protrusions 71 are arranged on the same circumference around the second swing axis A2. The axial center protrusion 71 protrudes in the axial direction of the second swing axis A2. Note that the housing recess 31m is an example of the “housing recess” of the present disclosure.

As illustrated in FIG. 18, the second support portion 60 has the axial center recess 61j. The axial center recess 61j is recessed in a direction opposite to the axial center protrusion 71. Specifically, the support body 61 of the second support portion 60 has the axial center recess 61j. The axial center recess 61j is disposed on the facing surface 61a. The axial center recess 61j constitutes at least a part of a circle around the second swing axis A2.

In the third variation, the axial center protrusion 71 moves along an inner surface of the axial center recess 61j. Therefore, similarly to the embodiment illustrated in FIGS. 1 to 14, the first support portion 30 can be stably swung with respect to the second support portion 60 about the second swing axis A2.

Note that, in the embodiment shown in FIGS. 1 to 14, the example in which the magnetic member 73 is disposed in the housing recess 61d is shown. However, the present disclosure is not limited to this example. That is, as illustrated in FIG. 18, the second support portion 60 does not need to have the housing recess 61d. In this case, the magnetic member 73 may be disposed on the facing surface 61a of the second support portion 60.

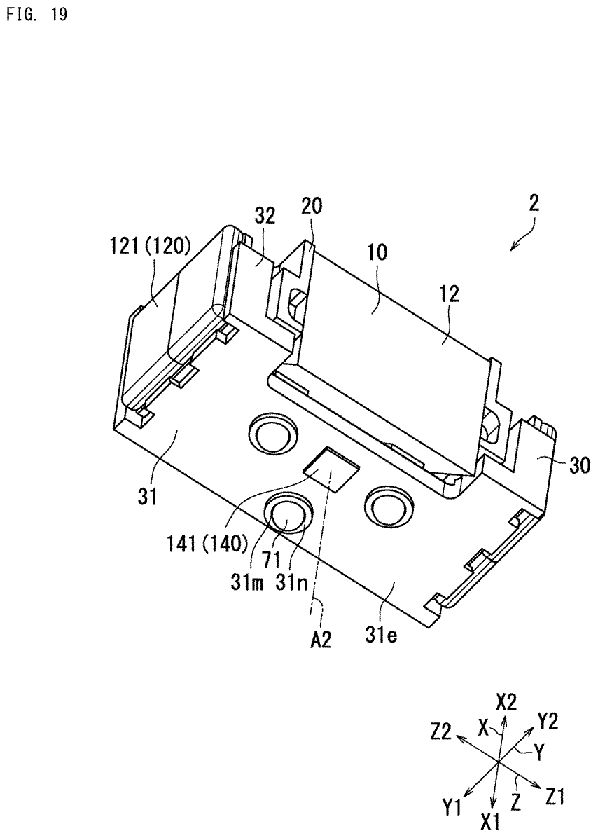

The fourth variation of the embodiment of the present disclosure will be described with reference to FIG. 19. FIG. 19 is a perspective view illustrating the movable body 2 of the optical unit 1 according to the fourth variation of the present embodiment. As illustrated in FIG. 19, in the fourth variation, the support body 31 of the first support portion 30 does not include the housing recess 31k. The magnetic member 141 of the second preload unit 140 is disposed on the lower facing surface 31e of the support body 31.

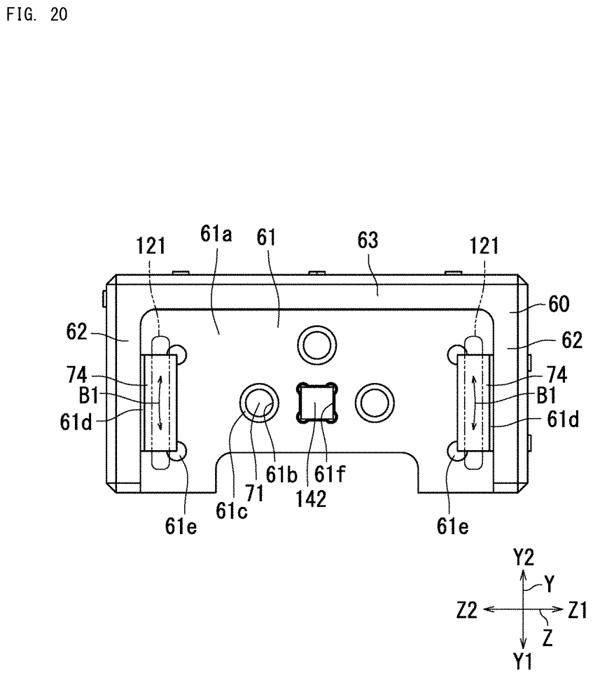

The fifth variation of the embodiment of the present disclosure will be described with reference to FIG. 20. In the fifth variation, a case where a magnetic member 74 extends along a swing direction of the second magnet 121 will be described. FIG. 20 is a diagram illustrating the second support portion 60, the axial center protrusion 71, the second magnet 121, and the third magnet 142 of the optical unit 1 according to the fifth variation of the present embodiment from the second side X2 in the first direction X.

As illustrated in FIG. 20, unlike the magnetic member 73 of the embodiment illustrated in FIGS. 1 to 14, only one magnetic member 74 is disposed for one second magnet 121. The magnetic member 74 extends along a swing direction B1 of the second magnet 121. Therefore, an attractive force acting between the second magnet 121 and the magnetic member 74 can be increased.

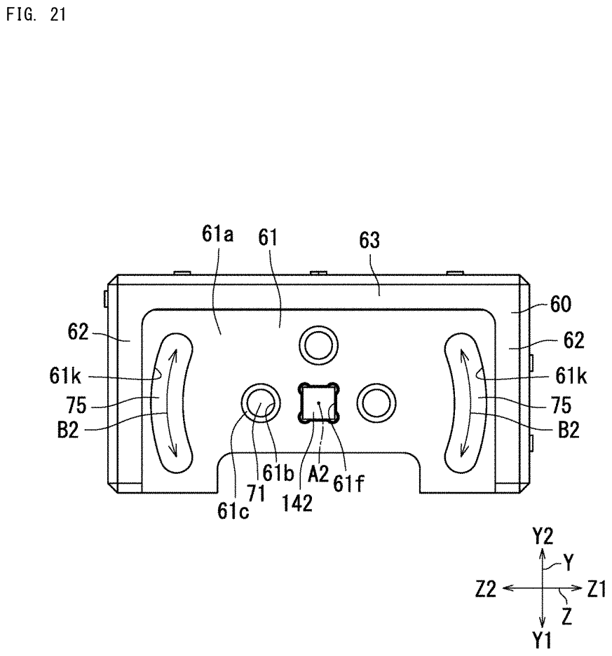

The sixth variation of the embodiment of the present disclosure will be described with reference to FIG. 21. In the sixth variation, a case where a magnetic member 75 has an arc shape around the second swing axis A2 will be described. FIG. 21 is a diagram illustrating the second support portion 60, the axial center protrusion 71, and the third magnet 142 of the optical unit 1 according to the sixth variation of the present embodiment from the second side X2 in the first direction X. As illustrated in FIG. 21, the magnetic member 75 extends along the swing direction of the second magnet 121 as in the fifth variation. Furthermore, the magnetic member 75 has an arc shape around the second swing axis A2. Unlike the housing recess 61d of the embodiment shown in FIGS. 1 to 14, a housing recess 61k has an arc shape around the second swing axis A2. That is, the magnetic member 75 and the housing recess 61k are curved along a direction B2.

Therefore, when the movable body 2 is swung about the second swing axis A2, it is possible to suppress a change in an area where the second magnet 121 and the magnetic member 75 overlap each other in the axial direction of the second swing axis A2. Therefore, it is possible to suppress fluctuation of an attractive force between the second magnet 121 and the magnetic member 75.

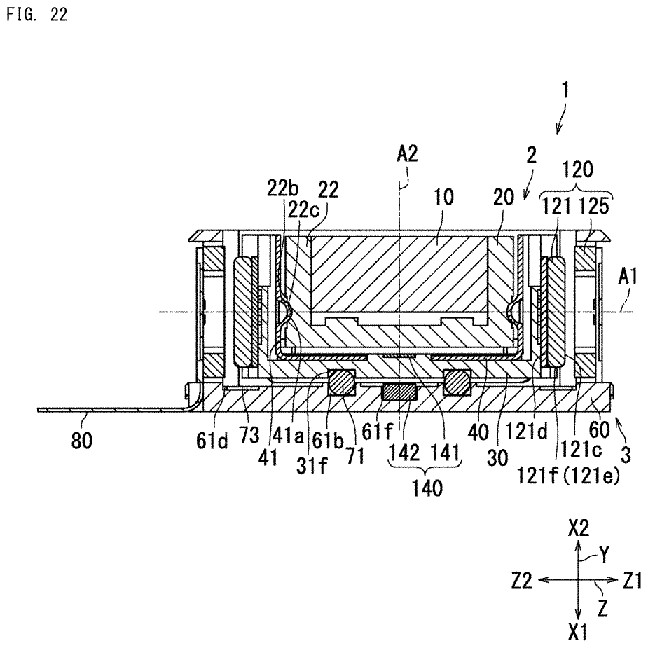

The seventh variation of the embodiment of the present disclosure will be described with reference to FIG. 22. FIG. 22 is a cross-sectional view illustrating the optical unit 1 according to the seventh variation of the present embodiment. As illustrated in FIG. 22, in the seventh variation, the magnetic member 141 of the second preload unit 140 is disposed on a surface on the holder 20 side of the first support portion 30. That is, the magnetic member 141 is disposed on a surface on the second side X2 in the first direction X of the first support portion 30.

Therefore, the magnetic member 141 presses the first support portion 30 toward the second support portion 60 by an attractive force between the magnetic member 141 and the third magnet 142. Therefore, it is not necessary to fix the magnetic member 141 to the first support portion 30 using, for example, an adhesive.

Note that, in the embodiment illustrated in FIGS. 1 to 14, the example in which the optical element 10 is composed of a prism is described. However, the present disclosure is not limited to this example. For example, a thin sheet-shaped reflection member (for example, a mirror) may be used as the optical element 10.

Further, in the embodiment illustrated in FIGS. 1 to 14, the example in which the first preload unit 40 is disposed on the first support portion 30 is described. However, the present disclosure is not limited to this example. The first preload unit that applies a preload in the axial direction of the first swing axis A1 may be disposed on the holder 20.

Further, in the present embodiment illustrated in FIGS. 1 to 14, the example in which at least three of the axial center protrusions 71 are disposed on the same circumference around the swing axis extending along the incident direction is described. However, the present disclosure is not limited to this. At least three axial center protrusions may be disposed on the same circumference around a swing axis extending in a direction intersecting the incident direction.

The embodiment (including the variations) of the present disclosure is described above with reference to the drawings. However, the present disclosure is not limited to the above embodiment, and can be implemented in various aspects within a range not departing from the gist of the present disclosure. Further, various disclosures can be formed by appropriately combining a plurality of constituents disclosed in the above embodiment. For example, some constituents may be deleted from all the constituents shown in the embodiment. For example, constituents of different embodiments may be appropriately combined. For easy understanding, the drawings schematically illustrate each constituent mainly, and the thickness, length, number, interval, and the like of each illustrated constituent may be different from the actual thickness, length, number, interval, and the like for convenience of creating the drawings. Further, the material, shape, dimension, and the like of each constituent shown in the above embodiment are merely examples, and are not particularly limited, and various modifications can be made within a range not substantially departing from the effects of the present disclosure.

The present disclosure can be applied to, for example, an optical unit.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An optical unit comprising:
a movable body having an optical element that changes a traveling direction of light;
a support that supports the movable body in a manner that the movable body is swingable about a swing axis; and
a swing mechanism that swings the movable body about the swing axis,
wherein
one of the movable body and the support has at least three protrusions protruding toward another one of the movable body and the support,
the other one of the movable body and the support has a recess recessed in a direction opposite to the protrusion,
the at least three protrusions are disposed on a same circumference around the swing axis and protrude in an axial direction of the swing axis, and
the recess is in contact with the protrusion and constitutes at least a part of a circle around the swing axis.

2. The optical unit according to claim 1, wherein
the at least three protrusions are disposed to be separated from each other on the same circumference.

3. The optical unit according to claim 1, wherein
the optical element has a reflection surface that reflects light traveling to a first side in a first direction to a first side in a second direction intersecting the first direction, and
the swing axis is an axis extending along the first direction.

4. The optical unit according to claim 3, wherein
the protrusion and the recess are disposed on the first side in the first direction with respect to the reflection surface.

5. The optical unit according to claim 4, wherein
the movable body has a support portion that supports the optical element,
the support portion is supported by the support so as to be swingable about the swing axis,
the support portion has a facing surface facing the support in the first direction,
the recess is disposed on the facing surface,
a part of the reflection surface protrudes to the first side in the first direction and the first side in the second direction with respect to the facing surface, and
the recess has a shape in which an end portion on the first side in the second direction of the circle is cut out.

6. The optical unit according to claim 5, wherein
two of the protrusions are disposed side by side in a third direction intersecting the first direction and the second direction, and
a remaining one of the protrusions is disposed on a circumference having the two protrusions as both ends of a diameter.

7. The optical unit according to claim 1, wherein
the support has the protrusion, and
the movable body has the recess.

8. The optical unit according to claim 1, wherein
the protrusion has at least a part of a spherical surface.

9. The optical unit according to claim 8, wherein
the protrusion is a sphere,
one of the movable body and the support has at least three housing recesses recessed in a direction opposite to another one of the movable body and the support, and
the housing recess houses a part of the protrusion.

10. The optical unit according to claim 1, wherein
number of the protrusions is three.

11. The optical unit according to claim 1, wherein
the recess constitutes at least a part of a circumference around the swing axis.

12. The optical unit according to claim 1, wherein
a material of the protrusion is metal.

13. The optical unit according to claim 1, wherein
a material of the protrusion is ceramic.

14. The optical unit according to claim 1, further comprising a preload unit that is disposed on at least one of the movable body and the support and applies a preload to at least another one of the movable body and the support in an axial direction of the swing axis.

15. The optical unit according to claim 14, wherein
the preload unit includes:
a magnet disposed on one of the movable body and the support; and
a magnetic member disposed on another one of the movable body and the support.
